(19) United States
(12) Patent Application Publication
(10) Pub. No.: US 2008/0158394 A1
(43) Pub. Date: Jul. 3, 2008

(54) PHOTOGRAPHING APPARATUS AND METHOD

(75) Inventor: Deog-min KIM, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/758,820

(22) Filed: Jun. 6, 2007

(30) Foreign Application Priority Data
Dec. 28, 2006 (KR) 2006-136574

(51) Int. Cl. H04N 5/262; H04N 5/228

(52) U.S. Cl. 348/240.99; 348/222.1; 348/E05.031; 348/E05.051

(57) ABSTRACT

A photographing apparatus and method to optimize a center point of an image sensor. The photographing apparatus includes a lens unit to photograph a first object at a predetermined reference angle and to photograph a second object, and a control unit to extract a center value of a first position that indicates, center of the reference angle according to an image signal that corresponds to the first object photographed by the lens unit, to extract a center value of a second position that indicates a center of the photographed image of the second object on according to the image signal that corresponds to the second object, and to correct the center value of the second position according to the extracted center value of the first position.

### CROSS-REFERENCE TO RELATED APPLICATIONS

This application claims priority under 35 U.S.C. § 119 (a) from Korean Patent Application No. 10-2006-0136574, filed on Dec. 28, 2006, in the Korean Intellectual Property Office, the entire disclosure of which is hereby incorporated by reference.

### BACKGROUND OF THE INVENTION

1. Field of the Invention

The present general inventive concept relates to a photographing apparatus and method. More particularly, the present general inventive concept relates to a photographing apparatus and a method of controlling a photographing, which can correct a center of an image being photographed by making a center of an image outputted during photographing using a zoom lens coincide with a center of an optical axis of the zoom lens.

2. Description of the Related Art

A photographing apparatus captures an image by sensing light reflected from an object using a charge coupled device. Such a photographing apparatus may be a digital video camera, a camcorder, and so forth.

Generally, a photographing apparatus is designed so that a center of a lens included in an optical system of the apparatus coincides with a center of an image sensor. However, in a process of assembling the optical system including the lens and the image sensor, the center of the lens may not coincide with the center of the image sensor due to a basic error, such as an installation error, an instrumental error, and so forth.

In the conventional photographing apparatus, however, jig and fixture are used to make the center of the lens coincide with the center of the image sensor, and this causes manufacturing cost and time to be increased.

### SUMMARY OF THE INVENTION

The present general inventive concept provides a photographing apparatus and a method of controlling a photographing, which can correct a center of an image being photographed by comparing centers of images photographed in a first zoom position and a second zoom position with each other, and making the center of the image coincide with the center of an optical axis of a zoom lens if the centers of the images photographed in the first zoom position and the second zoom position are different from each other.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a photographing apparatus, including a lens unit to photograph a first object at a predetermined reference angle and to photograph a second object, and a control unit to extract a center value of a first position that indicates a center of the reference angle according to an image signal that corresponds to the first object photographed by the lens unit, to extract a center value of a second position that indicates a center of the photographed image of the second object according to the image signal that corresponds to the second object, and to correct the center value of the second position according to the extracted center value of the first position.

The lens unit may perform a zoom-photographing of the first object and the second object.

The control unit may extract an image signal of a predetermined reference region according to the reference angle among the image signal that corresponds to the first object photographed by the lens unit and the center value of the first position, extract the image signal of the predetermined reference region among the image signal that corresponds to the second object and the center value of the second position, calculate a first position difference value that indicates a difference in at least one of a vertical direction, a horizontal direction, and a distance between the center value of the second position and the center value of the first position, and correct the center value of the second position using the calculated first position difference value.

The control unit may verify the corrected center value of the second position after correcting the center value of the second position.

The control unit may determine whether the corrected center value of the second position coincides with the center value of the first position, and if the corrected center value of the second position does not coincide with the center value of the first position, it may calculate a second position difference value that indicates a difference in vertical direction, horizontal direction, and distance between the corrected center value of the second position and the center value of the first position. In this case, the control unit may verify the corrected center value of the second position by determining that the correction of the corrected center value of the second position has been properly made if the second position difference value is within a predetermined error range, and determining that the correction of the corrected center value of the second position has been wrongly made if the second position difference value is not within the predetermined error range.

If the second position difference value is not within a predetermined error range, the control unit may correct the center value of the second position by making the corrected center value of the second position become the center value of the first position within the error range by using the second position difference value.

The foregoing and/or other aspects and utilities of the present general inventive concept are also achieved by providing According to still another aspect of embodiments of the present invention, there is provided a method of controlling a photographing, which includes photographing a first object at a predetermined reference angle and photographing a second object, and extracting a center value of a first position that indicates the center of the reference angle according to an image signal that corresponds to the first object photographed by the lens unit, extracting a center value of a second position that indicates the center of the photographed image of the second object according to the image signal that corresponds to the second object, and correcting the center value of the second position according to the extracted center value of the first position.

The photographing may include performing a zoom-photographing of the first object and the second object.

The correcting of the center value may include extracting an image signal of a predetermined reference region according to the reference angle among the image signal that corresponds to the first object photographed by the lens unit and the center value of the first position, extracting the image signal of the predetermined reference region among the image signal that corresponds to the second object and the center value of the second position, calculating a first position difference value that indicates a difference in vertical direction, horizontal direction, and distance between the center value of the second position and the center value of the first position, and correcting the center value of the second position using the calculated first position difference value.

The correcting of the center value may include verifying the corrected center value of the second position after correcting the center value of the second position.

The correcting of the center value may include determining whether the corrected center value of the second position coincides with the center value of the first position, and if the corrected center value of the second position does not coincide with the center value of the first position, calculating a second position difference value that indicates a difference in vertical direction, horizontal direction, and distance between the corrected center value of the second position and the center value of the first position. In this case, the correcting step may include determining that the correction of the corrected center value of the second position has been properly made if the second position difference value is within a predetermined error range, and determining that the correction of the corrected center value of the second position has been wrongly made if the second position difference value is not within the predetermined error range, to verify the corrected center value of the second position.

The correcting of the center value may include correcting the center value of the second position by making the corrected center value of the second position become the center value of the first position within the error range by using the second position difference value if the second position difference value is not within a predetermined error range.

The foregoing and/or other aspects and utilities of the present general inventive concept are also achieved by providing a photograph apparatus, including a lens unit, and a control unit to control the lens unit to acquire a first photograph of an object at a first reference angle, zoom and acquire a second photograph of a second object at a second reference angle, and correct a center value of the second photograph according to a center value of the first photograph.

The foregoing and/or other aspects and utilities of the present general inventive concept are also achieved by providing a method of optimizing a center of an image sensor, the method including acquiring a first photograph of an object at a first reference angle, zooming to acquire a second photograph of a second object at a second reference angle, and correcting a center value of the second photograph according to a center value of the first photograph.

The foregoing and/or other aspects and utilities of the present general inventive concept are also achieved by providing a method to optimize a center of an image sensor, the method including acquiring a first photograph of an object at a first reference angle, acquiring a second photograph of an object, extracting a center value position for the first photograph, extracting a center value position for the second photograph, correcting the center value position for the second photograph according to the center value of the first photograph.

The extracting of the center value of the first photograph may include setting a center of the reference angle as the center value of the first photograph.

The acquiring of the first photograph may be performed at a first zoom and position and the acquiring of the second photograph may be performed at a second zoom position.

The correcting of the center value position may include comparing the extracted center value positions of the first photograph and second photograph corresponding to respective first and second reference regions, determining deviation values of the extracted center value position of the second photograph with respect to the extracted center value position of the first photograph, and correcting the center value position for the second photograph according to the deviation values if the deviation values are outside a predetermined range.

The correcting of the center value position may include applying correction values to correct the center value of the second photograph corresponding to the deviation values.

The acquiring of the first photograph may be performed at a first zoom and position and the acquiring of the second photograph may be performed at a second zoom position, and the correction values may be applied to the second zoom position.

The method may further include storing the correction values to apply to photographs acquired at the second zoom position, and applying stored correction values before extracting the center value position for the second photograph if the second photograph is taken at the second zoom position.

The correcting of the center value position further may include verifying the corrected center value position of the second photograph.

The verifying of the corrected center value position may include superimposing the second reference region over the first reference region, magnifying the second reference region at a predetermined magnification, and determining whether the corrected center value position coincides to the center value position of the first photograph or is within a predetermined error range, wherein if the corrected center value coincides or is within the predetermined error range, the correction values are stored to apply to photographs acquired at the second zoom position.

The foregoing and/or other aspects and utilities of the present general inventive concept are also achieved by providing a computer readable recording medium comprising computer readable codes to optimize a center of an image sensor, including acquiring a first photograph of an object at a first reference angle, acquiring a second photograph of an object, extracting a center value position for the first photograph, extracting a center value position for the second photograph, and correcting the center value position for the second photograph according to the center value of the first photograph.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a block diagram illustrating a photographing apparatus according to an embodiment of the present general inventive concept;

FIGS. 2A to 2C are views illustrating a zoom position correction in a photographing apparatus according to an embodiment of the present general inventive concept; and

FIG. 3 is a flowchart illustrating a method of operating the photographing apparatus according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

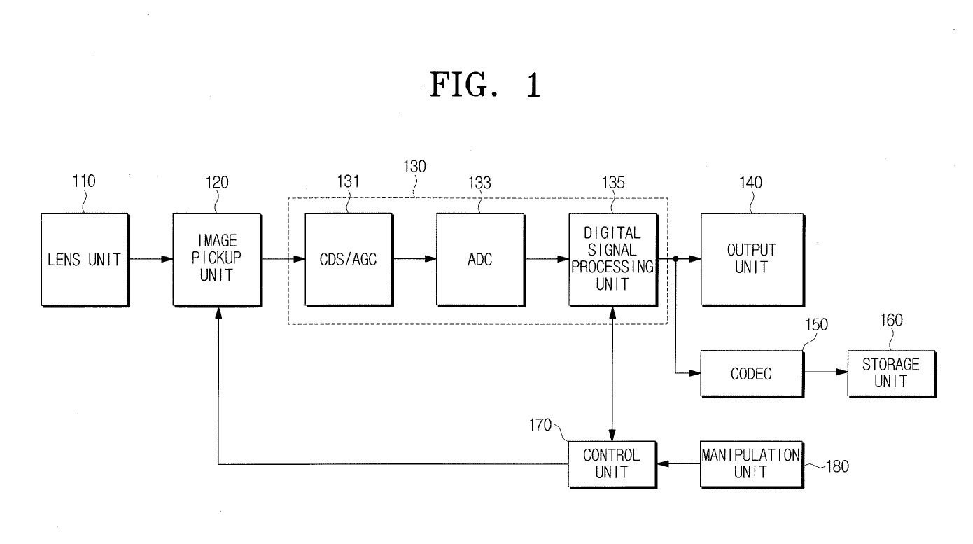

FIG. 1 is a block diagram illustrating a photographing apparatus according to an embodiment of the present general inventive concept.

Referring to FIG. 1, the photographing apparatus according to an embodiment of the present general inventive concept may include a lens unit 110, an image pickup unit 120, an image signal processing unit 130, an output unit 140, a codec 150, a storage unit 160, a control unit 170, and a manipulation unit 180.

The lens unit 110 may include a zoom lens (not illustrated) to magnify or reduce a size of an object, a focus lens (not illustrated) to adjust the focus of the object, and an iris (not illustrated) to adjust a quantity of light, and the lens unit 110 receives an optical signal from the external object.

The image pickup unit 120 may include an image pickup device to convert an optical signal of the object that is incident through the lens unit 110. A charge coupled device (CCD) or CMOS may be used as the image pickup device.

The image signal processing unit 130 performs a processing of an electric signal outputted from the image pickup unit 120, such as a gain control, a noise removal, a gamma correction, a luminance signal separation, an image signal compression, and so forth. To perform such operations, the image signal processing unit 130 may include a CDS/AGC unit 131, an analog-to-digital (AD) conversion unit 133, and a digital signal processing unit 135.

The CDS/AGC unit 131 may remove a noise included in the electric signal inputted from the image pickup unit 120, and adjusts a gain so as to keep the level of the input image signal constant.

The AD conversion unit 133 may convert the analog image signal inputted from the CDS/AGC unit 131 into a digital image signal.

The digital signal processing unit 135 may separate a luminance signal from the digital image signal outputted from the AD conversion unit 133, and then outputs the processed image signal to the output unit 140.

The codec 150 may compress the image signal inputted from the digital signal processing unit 135 in a specified format and stores the compressed image signal in the storage unit 160. The codec 150 can expand the compressed data read from the storage unit 160 if necessary.

In the storage unit 160, various kinds of programs required to drive the photographing apparatus 100, a predetermined center value of a first zoom position, and a reference angle A can be stored.

If a zoom command is received from the manipulation unit 180, the control unit 170 controls the lens unit 110 to perform a zoom-photographing of an object to be photographed at the reference angle A with reference to the storage unit 160.

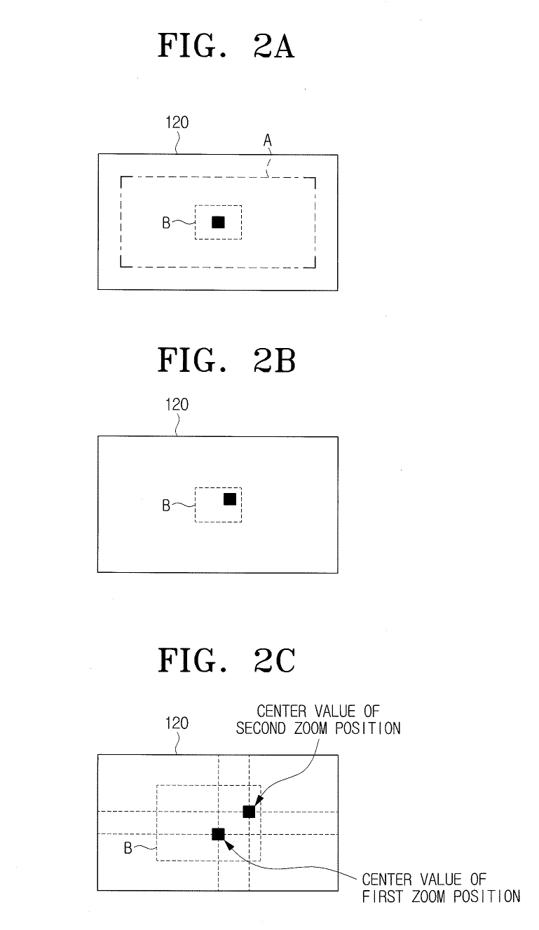

Specifically, referring to FIG. 2A, if a manipulation module to operate a zoom function, such as a zoom button provided in the manipulation unit 180, is driven by a developer or a user, the control unit 170 controls the lens unit 110 to perform a zoom-photographing of the object at a center of the predetermined reference angle A.

The control unit 170 can store in the storage unit 160 an image signal of a reference region B predetermined according to the center of the reference angle A and a center value of the first zoom position, among the image signal inputted from the digital signal processing unit 135. The center value of the first zoom position can then be determined according to the predetermined reference angle A. That is, the center of the reference angle A becomes the center value of the first zoom position. In this case, the control unit 170 can store in the storage unit 160 not only the image signal of the reference region B but also the whole photographed image signal.

In addition, if the zoom command is received again from the manipulation unit 180, the control unit 170 controls the lens unit 110 to perform another zoom-photographing of the object. Referring to FIG. 2B, the control unit 170 stores in the storage unit 160 the image signal of a reference region B predetermined in the same manner as the first zoom photographing and a center value of a second zoom position. The center value of the second zoom position can be determined according to the stored reference region B of the zoom-photographing at the second zoom position. The control unit, with reference to the storage unit 160, compares the center value of the first zoom position with the center value of the second zoom position zoom-photographed again.

If the center value of the first zoom position does not coincide with the center value of the second zoom position as a result of comparison, the control unit 170 calculates a first position difference value that indicates vertical/horizontal directions of the center value of the second zoom position according to the center value of the first zoom position and a difference in distance between the center values of the first and second zoom positions. For example, the control unit 170 calculates and confirms that the center value of the second zoom position is deviated by two pixels in a left direction and by two pixels in a downward direction, from the center value of the first zoom position. The control unit 170 corrects the center value of the second zoom position to the deviated position.

In addition, referring to FIG. 2C, the control unit 170 can superimpose the corrected center value of the second zoom position on the reference angle A that includes the center value of the first zoom position, and then magnifies the superimposed region with predetermined magnifications. If the magnified center value of the first zoom position coincides with the center value of the second zoom position, or the second position difference value that indicates the difference between the center values of the first zoom position and the second zoom position is within a predetermined error range, the control unit 170 stores the first position difference value in the storage unit 160. That is, the control unit 170 determines that the correction of the center value of the second zoom position has been properly made, and stores the first position difference value in the storage unit 160.

If the center value of the first zoom position and the corrected center value of the second zoom position are not within the predetermined error range, the control unit 170 corrects again the corrected center value of the second zoom position in the same manner as the correction of the center value of the second zoom position. That is, the control unit calculates the vertical/horizontal directions of the center value of the first zoom position and the corrected center value of the second zoom position and the difference in distance between them, and corrects again the corrected center value of the second zoom position according to the calculated directions and difference in distance.

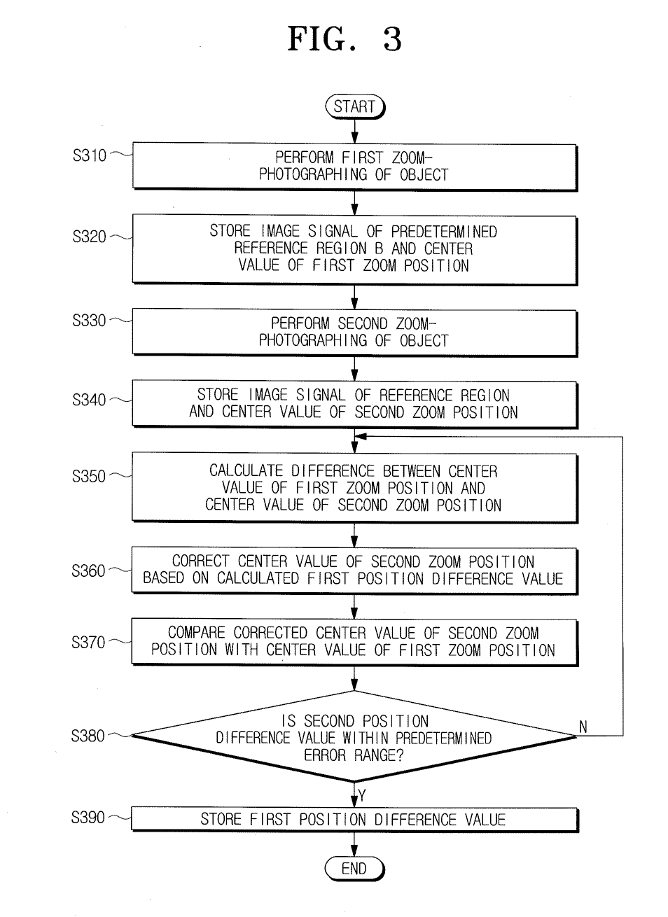

FIG. 3 is a flowchart illustrating a method of operating the photographing apparatus according to an embodiment of the present general inventive concept.

Referring to FIG. 3, if the zoom command is first received, the lens unit 110 places the focus on a center of a predetermined reference angle A, and performs a zoom-photographing of an object to be photographed in operation S310.

Specifically, if a manipulation module to operate a zoom function, such as a zoom button provided in the manipulation unit 180, is driven by a developer, the lens unit 110 performs the zoom-photographing of the object at the center of the predetermined reference angle A under the control of the control unit 170.

Then, the control unit 170 stores in the storage unit 160 an image signal of a reference region B predetermined according to the center of the reference angle A and a center value of the first zoom position among the photographed image signal in operation S320. Here, the center of the reference angle A becomes the center value of the reference angle A. In this case, the control unit 170 can store not only the image signal of the reference region B but also the whole photographed image signal.

Then, if a second zoom command is received, the lens unit 110 performs a zoom-photographing of the object to be photographed in operation S330. When the second zoom command is received after photographing the first object to be photographed in operation S310, the lens unit 110 performs the zoom-photographing of the second object to be photographed. Here, the first object and the second object may be the same object or different objects.

Then, the control unit 170 stores in the storage unit 160 an image signal of the predetermined reference region B among the image signal photographed according to the second zoom command and a center value of the second zoom position in operation S340. Here, the center value of the second zoom position is a center position value of the secondly zoom-photographed image.

Then, the control unit 170 calculates the first position difference value by comparing the pre-stored center value of the first zoom position with the center value of the second zoom position in operation S350.

Specifically, the control unit 170 calculates the first position difference value that indicates how far the vertical/horizontal directions and the distance of the center value of the second zoom position stored in operation S340 deviate from those of the center value of the first zoom position.

Then, the control unit 170 corrects the center value of the second zoom position to the deviated position calculated according to the calculated position difference value in operation S360.

That is, referring to FIG. 2C, the control unit corrects the center value of the second zoom position in the reference region B by x pixels in a left direction and by y pixels in a downward direction. Here, the first position difference value corresponds to x pixels in the left direction and y pixels in the downward direction.

Then, the control unit 170 compares the corrected center value of the second zoom position with the pre-stored center value of the first zoom position in operation S370.

If there is a difference between the center value of the first zoom position stored in operation S320 and the center value of the second zoom position corrected in operation S360, the control unit 170 calculates the second position difference value that is the difference value between the center values of the first and second zoom positions. At this time, the control unit 170 verifies whether the center value of the first zoom position and the corrected center value of the second zoom position have been properly corrected using the calculated second position difference value. Since the method of calculating the second position difference value that is the difference value between the corrected center value of the second zoom position and the center value of the first zoom position is similar to operation S350, the detailed explanation thereof will be omitted.

Then, the control unit 170 determines whether the calculated second position difference value is within the predetermined error range in operation S380.

If it is judged that the second position difference value is within the error range (“Y” in operation S380), the control unit 170 stores the first position difference value used to correct the center value of the second zoom position in operation S390. That is, the control unit 170 stores in the storage unit 160 the first position difference value used to correct the center value of the second zoom position in operation S360.

On the other hand, if it is judged that the second position difference value is not within the predetermined error range (“N” in operation S380), the control unit 170 calculates the difference value between the corrected center value of the second zoom position and the center value of the first zoom position, and corrects again the center value of the second zoom position to the center value of the first zoom position by using the difference value. The control unit 170 continues this correction process until the corrected center value of the zoom position is within the error range.

Various embodiments of the present general inventive concept can be embodied as computer readable codes on a computer-readable medium. The computer-readable medium includes a computer-readable recording medium and a computer-readable transmission medium. The computer readable recording medium may include any data storage device suitable to store data that can be thereafter read by a computer system. Examples of the computer readable recording medium include, but are not limited to, a read-only memory (ROM), a random-access memory (RAM), CD-ROMs, magnetic tapes, floppy disks, optical data storage devices, and carrier waves (such as data transmission through the Internet). The computer readable transmission medium can be distributed over network coupled computer systems, through wireless or wired communications over the internet, so that the computer readable code is stored and executed in a distributed fashion. Various embodiments of the present general inventive concept may also be embodied in hardware or in a combination of hardware and software.

As described above, according to the present general inventive concept, the centers of images photographed at first and second zoom positions are compared with each other, and if the centers are different from each other, the center value of the second zoom position is corrected according to the center value of the first zoom position to make the center of the image coincide with the center of an optical axis of a zoom lens, so that the center of the image being photographed can be corrected.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A photographing apparatus, comprising:
a lens unit to photograph a first object at a predetermined reference angle and to photograph a second object; and
a control unit to extract a center value of a first position that indicates a center of the reference angle according to an image signal that corresponds to the first object photographed by the lens unit, to extract a center value of a second position that indicates a center of the photographed image of the second object according to the image signal that corresponds to the second object, and to correct the center value of the second position according to the extracted center value of the first position.

2. The photographing apparatus of claim 1, wherein the lens unit performs a zoom-photographing of the first object and the second object.

3. The photographing apparatus of claim 1, wherein the control unit extracts an image signal of a predetermined reference region according to the reference angle among the image signal that corresponds to the first object photographed by the lens unit and the center value of the first position, extracts the image signal of the predetermined reference region among the image signal that corresponds to the second object and the center value of the second position, calculates a first position difference value that indicates a difference in at least one of a vertical direction, a horizontal direction, and a distance between the center value of the second position and the center value of the first position, and corrects the center value of the second position using the calculated first position difference value.

4. The photographing apparatus of claim 1, wherein the control unit verifies the corrected center value of the second position after correcting the center value of the second position.

5. The photographing apparatus of claim 4, wherein:
the control unit determines whether the corrected center value of the second position coincides with the center value of the first position, and if the corrected center value of the second position does not coincide with the center value of the first position, calculates a second position difference value that indicates a difference in vertical direction, horizontal direction, and distance between the corrected center value of the second position and the center value of the first position, and
the control unit verifies the corrected center value of the second position by determining that the correction of the corrected center value of the second position has been properly made if the second position difference value is within a predetermined error range, and determining that the correction of the corrected center value of the second position has been wrongly made if the second position difference value is not within the predetermined error range.

6. The photographing apparatus of claim 5, wherein if the second position difference value is not within a predetermined error range, the control unit corrects the center value of the second position by making the corrected center value of the second position become the center value of the first position within the error range by using the second position difference value.

7. A method of controlling a photographing, comprising:
photographing a first object at a predetermined reference angle and photographing a second object; and
extracting a center value of a first position that indicates the center of the reference angle according to an image signal that corresponds to the first object photographed by the lens unit, extracting a center value of a second position that indicates the center of the photographed image of the second object according to the image signal that corresponds to the second object, and correcting the center value of the second position according to the extracted center value of the first position.

8. The method of claim 7, wherein the photographing comprises performing a zoom-photographing of the first object and the second object.

9. The method of claim 7, wherein the correcting of the center value comprises extracting an image signal of a predetermined reference region according to the reference angle among the image signal that corresponds to the first object photographed by the lens unit and the center value of the first position, extracting the image signal of the predetermined reference region among the image signal that corresponds to the second object and the center value of the second position, calculating a first position difference value that indicates a difference in vertical direction, horizontal direction, and distance between the center value of the second position and the center value of the first position, and correcting the center value of the second position using the calculated first position difference value.

10. The method of claim 7, wherein the correcting of the center value comprises verifying the corrected center value of the second position after correcting the center value of the second position.

11. The method of claim 10, wherein the correcting of the center value comprises:
determining whether the corrected center value of the second position coincides with the center value of the first position, and if the corrected center value of the second position does not coincide with the center value of the first position, calculating a second position difference value that indicates a difference in vertical direction, horizontal direction, and distance between the corrected center value of the second position and the center value of the first position; and
determining that the correction of the corrected center value of the second position has been properly made if the second position difference value is within a predetermined error range, and determining that the correction of the corrected center value of the second position has been wrongly made if the second position difference value is not within the predetermined error range, to verify the corrected center value of the second position.

12. The method of claim 11, wherein the correcting of the center value comprises correcting the center value of the second position by making the corrected center value of the second position become the center value of the first position within the error range by using the second position difference value if the second position difference value is not within a predetermined error range.

13. A photograph apparatus, comprising:
a lens unit; and
a control unit to control the lens unit to acquire a first photograph of an object at a first reference angle, zoom and acquire a second photograph of a second object at a second reference angle, and correct a center value of the second photograph according to a center value of the first photograph.

14. A method of optimizing a center of an image sensor, the method comprising:
acquiring a first photograph of an object at a first reference angle;
zooming to acquire a second photograph of a second object at a second reference angle; and
correcting a center value of the second photograph according to a center value of the first photograph.

15. A method to optimize a center of an image sensor, the method comprising:
acquiring a first photograph of an object at a first reference angle;
acquiring a second photograph of an object;
extracting a center value position for the first photograph;
extracting a center value position for the second photograph; and
correcting the center value position for the second photograph according to the center value of the first photograph.

16. The method of claim 15, wherein the extracting of the center value of the first photograph comprises setting a center of the reference angle as the center value of the first photograph.

17. The method of claim 15, wherein the acquiring of the first photograph is performed at a first zoom and position and the acquiring of the second photograph is performed at a second zoom position.

18. The method of claim 15, wherein the correcting of the center value position comprises:
comparing the extracted center value positions of the first photograph and second photograph corresponding to respective first and second reference regions;
determining deviation values of the extracted center value position of the second photograph with respect to the extracted center value position of the first photograph; and
correcting the center value position for the second photograph according to the deviation values if the deviation values are outside a predetermined range.

19. The method of claim 18, wherein the correcting of the center value position comprises applying correction values to correct the center value of the second photograph corresponding to the deviation values.

20. The method of claim 19, wherein:
the acquiring of the first photograph is performed at a first zoom and position and the acquiring of the second photograph is performed at a second zoom position, and
the correction values are applied to the second zoom position.

21. The method of claim 20, further comprising:
storing the correction values to apply to photographs acquired at the second zoom position; and
applying stored correction values before extracting the center value position for the second photograph if the second photograph is taken at the second zoom position.

22. The method of claim 18, wherein the correcting of the center value position further comprises verifying the corrected center value position of the second photograph.

23. The method of claim 22, wherein the verifying of the corrected center value position comprises:
superimposing the second reference region over the first reference region;
magnifying the second reference region at a predetermined magnification; and
determining whether the corrected center value position coincides to the center value position of the first photograph or is within a predetermined error range,
wherein if the corrected center value coincides or is within the predetermined error range, the correction values are stored to apply to photographs acquired at the second zoom position.

24. A computer readable recording medium comprising computer readable codes to optimize a center of an image sensor, comprising:
acquiring a first photograph of an object at a first reference angle;
acquiring a second photograph of an object;
extracting a center value position for the first photograph;
extracting a center value position for the second photograph; and
correcting the center value position for the second photograph according to the center value of the first photograph.
